(19) United States
(12) Patent Application Publication
(10) Pub. No.: US 2005/0144180 A1
(43) Pub. Date: Jun. 30, 2005

(54) Returning details of entities from a UDDI registry

(76) Inventor: John Colgrave, Eastleigh (GB)

Correspondence Address: IBM CORPORATION;INTELLECTUAL PROPERTY LAW, 11400 BURNET ROAD, AUSTIN, TX, 78758, US

(21) Appl. No.: 10/965,107

(22) Filed: Oct. 14, 2004

(30) Foreign Application Priority Data
Dec. 30, 2003 (GB) 0330164.5

(51) Int. Cl. G06F 17/00

(52) U.S. Cl. 707/100

(57) ABSTRACT

The present invention provides a method, apparatus, computer program product, and service which enables a UDDI registry to provide support for external ordering of entities. When a service requester contacts the registry to obtain details of entities which meet specified criteria, the registry locates a plurality of entities and provides details of these to an external ordering service. The external ordering service then orders the list according to a particular criteria, such that an ordered list is returned to the service requester. For example an entity could be a business, service, binding, or tModel.

### FIELD OF THE INVENTION

The present invention relates to returning details of entities from a UDDI registry and more particularly to the order in which details of entities are returned to a requester.

### BACKGROUND TO THE INVENTION

Over recent years it has become commonplace for a business to provide the ability for a user to purchase goods from the business using a computer which communicates with a computer of the business. For example a business may provide a web site on the Internet which enables a user to purchase goods from the business over the world wide web. Following on from this success it has become a requirement to more easily locate suitable businesses to deal with. This requirement has been satisfied by the arrival of registry services, such as specified by UDDI (Universal Description, Discovery and Integration), which provide support for business entities which provide services.

UDDI is an industry effort to provide directory services for Web Services offered by businesses. The UDDI specification provides structural templates for representing information about business entities, the nature of their services, and mechanisms to access them. These are facilitated by standards such as Web Services Definition Language (WSDL), and Simple Object Access Protocol (SOAP). It also provides a standardized set of categories such as North American Industry Classification System (NAICS) and United Nations Standard Product and Services Classification (UNSPSC) for organizing the services offered by businesses in the directory to enable quick business-level and service-level discovery.

For example, a UDDI registry enables a business entity to publish information about the services it provides and a user to discover information about published business services. Accordingly, for example, a user can send a request to a UDDI registry to obtain details of business services which meet specified criteria. In response the UDDI registry returns a list of business services which satisfy those criteria. The user then chooses from the one or more business services returned by the UDDI registry and sends an appropriate request to the chosen business service. However, the order in which the business services are specified in the returned list is limited to name and/or date which can make it difficult for a client to choose the most appropriate business service to itself.

### SUMMARY OF THE INVENTION

The present invention provides a new method, apparatus, computer program product and service for providing an external ordering feature in a UDDI registry which can order the list of details of business services returned to a client requester based on a specific policy or criteria.

Accordingly the present invention provides a data processing method for a UDDI registry to order a list of entity details for return to a requester, the method comprising the steps: receiving, from the requester, a standard UDDI request to locate entity details according to a specified criteria; locating details of a plurality of entities which satisfy the criteria; invoking an ordering service for ordering, based on a policy, the plurality of entity details into an ordered list; returning the ordered list to the requester.

According to a second aspect the present invention provides a UDDI registry for ordering a list of entity details for return to a requester, the registry comprising: means for receiving, from the requester, a standard UDDI request to locate entity details according to a specified criteria; means for locating details of a plurality of entities which satisfy the criteria; means for invoking an ordering service for ordering, based on a policy, the plurality of entity details into an ordered list; and means for returning the ordered list to the requester.

According to a third aspect the present invention provides a UDDI registry service for ordering a list of entity details for return to a requester, providing the UDDI registry service comprising carrying out the method of the first aspect.

For example, the standard UDDI request could be based on UDDI version 3. For example an entity could be a business, service, binding, or tModel.

Preferably the UDDI registry accepts registration of ordering services such that an ordering services can be registered by an external (to the UDDI) provider.

Optionally, if the UDDI registry has access to plurality of ordering services, a plurality of services are invoked to order a list of entity details, each subsequently invoked ordering service refining the ordered list of the previously invoked ordering service.

Optionally, if the UDDI registry has access to plurality of ordering services, the UDDI registry can select one or more ordering services to invoke based on, for example, chronological data or information received with the client request. If chronological data is used, for example, a different ordering service can be called at different times of the day, days of the week, or weeks of the year.

According to a fourth aspect the present invention provides a data processing method for an ordering service to order a list of entity details provided by a UDDI registry, the method comprising the steps: receiving a request from the UDDI registry, the request including a list of entity details; ordering the list of entity details based on a policy; and returning the ordered list to the UDDI registry.

According to a fifth aspect the present invention provides an ordering service for to order a list of entity details provided by a UDDI registry ordering a list of entity details provided by a UDDI registry, the service comprising: means for receiving a request from the UDDI registry, the request including a list of entity details; means for ordering the entity details based on a policy; and means for returning the ordered list to the UDDI registry.

According to a sixth aspect the present invention provides an ordering service for ordering a list of entity details provided by a UDDI registry, providing the service comprising carrying out the method according to the fourth aspect.

According to a seventh aspect the present invention provides a computer program product comprising instructions which, when executed on a data processing host, cause said host to carry out a method according to the first or fourth aspect.

Optionally the policy used to sort the list of entity details is based on an attribute associated with the entities. For example the attribute may be one or more of: a subscription level; a preference level; and a reliability level. For example, the provider of an entity may pay a subscription and the higher the subscription paid the earlier in the ordered list the entity's details are placed. For example, a preference value for requesters to use specific entities may be known and the ordering service places the more preferred entities earlier in the ordered list. For example, a reliability value of specific entities may be known based on previous use and the ordering service places the more reliable entities earlier in the ordered list. For example, a rating may be associated with entities as a result of a calculation based on a combination of values, for example, preference and reliability values associated with the entity, and the higher the rating of an entity the earlier in the ordered list the entity's details are placed.

### BRIEF DESCRIPTION OF THE DRAWINGS

The invention will now be described, by way of example only, with reference to a preferred embodiment thereof, as illustrated in the accompanying drawings, in which:

FIG. 1 is a schematic diagram of a data processing system in which the preferred embodiment of the present invention can be advantageously applied;

FIG. 2 is a schematic diagram of a UDDI registry which provides an external ordering service;

FIG. 3 is a WSDL description of an interface of an external ordering service; and

FIG. 4 is a flow diagram of a method for the UDDI registry to process an inbound request from a service requester to locate details of services with use of an external ordering service.

### DESCRIPTION OF THE PREFERRED EMBODIMENT

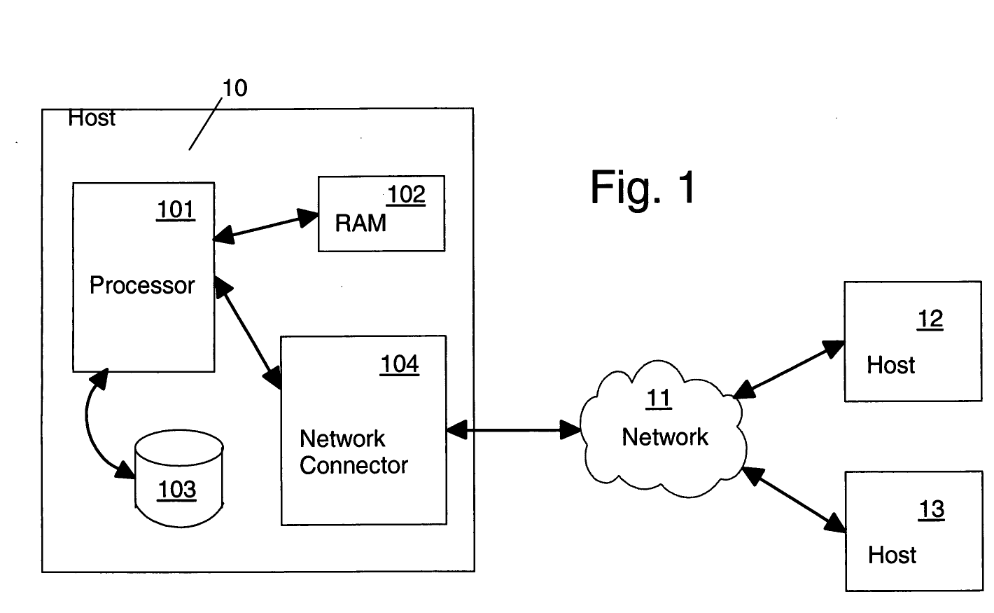

In FIG. 1, a client/server data processing host 10 is connected to other client/server data processing host 12 and 13 via a network 11, which could be, for example, the Internet. In the preferred embodiment a UDDI registry may be installed on any such client/server and accept requests to define/update details of an entity, or obtain details of an entity, from a user using the same or another client/server data processing host. For example an entity could be a business, service, binding, or tModel. The UDDI registry may further accept requests for registration of external ordering services. Client/server 10 has a processor 101 for executing programs that control the operation of the client/server 10, a RAM volatile memory element 102, a non-volatile memory 103, and a network connector 104 for use in interfacing with the network 11 for communication with the other client/servers 12 and 13.

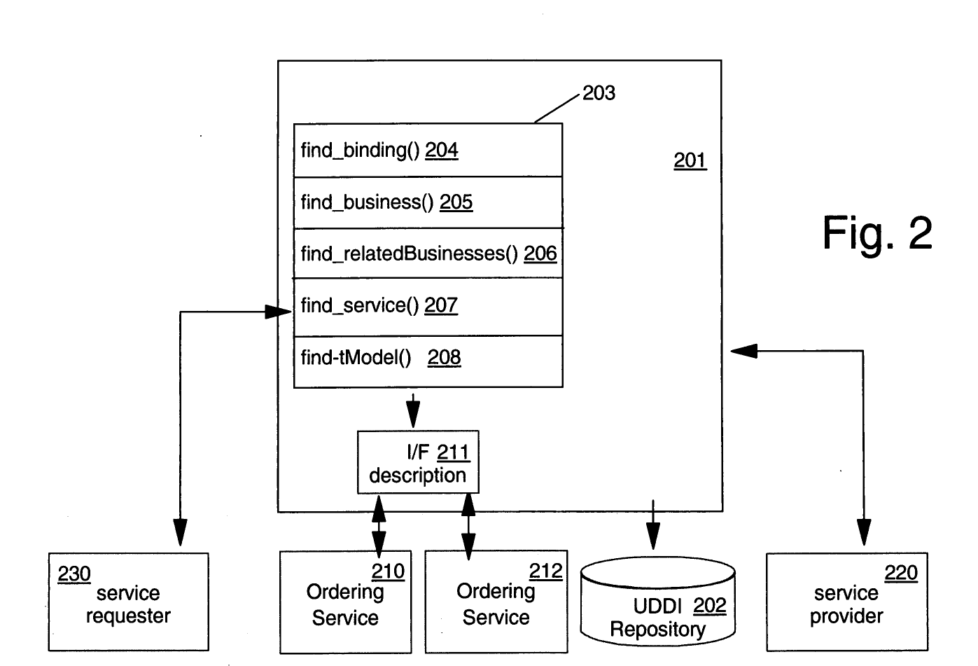

FIG. 2 is a schematic diagram of a UDDI registry 201 providing, in response to a request, external ordering of details of entities, which match specified criteria, according to the preferred embodiment of the present invention.

The UDDI registry 201 maintains details of services and businesses, and their associated capabilities, in a UDDI repository 202. In order to facilitate requesters obtaining such details from the UDDI registry it makes a requester API 203 available which includes the operations find_binding( ) 204, find_business( ) 205, find_relatedbusinesses( ) 206, find_service( ) 207 and find_tModel( ) 208. When the requester 230 wishes to obtain entity details it sends a request for one of these operations, for example a find_service( ), to the UDDI registry specifying a criteria on which services can be selected for return. On receipt of this request the UDDI registry searches the UDDI repository for details of appropriate entities and if a plurality of entities are found these are formed into a list for return to the requester.

However, the UDDI registry further has access to external ordering services 210 and 212 which have registered with the UDDI registry by providing a binding template (not shown) which references the standard interface description 211. The interface description provides details of the ordering operations which must be provided by an external ordering service for ordering entity details. For example, one such ordering operation can be defined for each of the operations defined in the requester API 203, alternatively for example, a single ordering operation could be provided for both find_business( ) and find_relatedbusinesses( ). An ordering operation takes input in the output format of the appropriate requester API operation, and returns output in the same format. For example, an operation for ordering bindings uses a bindingDetail as both input and output, because this is the format of the output of find_binding( ). Accordingly an ordering service operation takes as input a list of entity details to be returned to the requester and outputs the same format list but with the entity details ordered according to a specific policy or criteria. For example, an external ordering service could order business services according to subscriptions to the UDDI registry from those businesses, so for example, the higher the level of subscription of a business the earlier in the list the business service details are included compared to businesses with lower or no subscriptions.

Accordingly once the UDDI registry has built a list of entities for return to the client, it searches for a binding template which provides an external ordering service and when it finds one or more it uses the interface description to call one or more of them to order the list according to a specific criteria. For example, if a plurality of ordering services have been registered a particular ordering service could be used at a particular time of day or time period.

Note that how the details of entities are ordered by the ordering service will depend in the information available in each entity to be ordered. Such information is defined in the UDDI specification and although any such information may be used for ordering, it is typically limited to a name and description information.

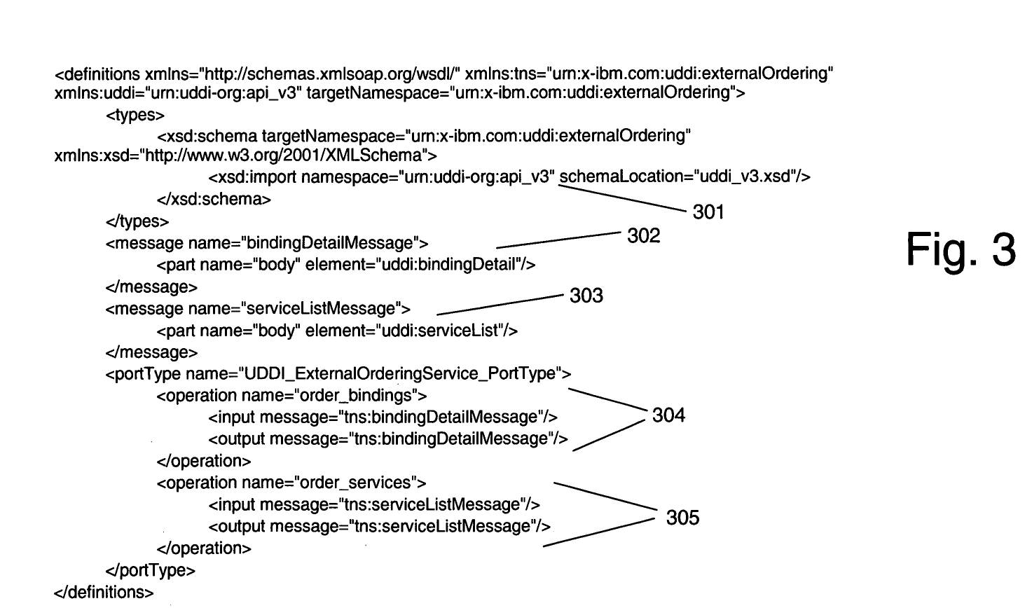

FIG. 3 shows an example of an interface description provided by an external ordering service when registering with the UDDI registry. However note that, for illustration purposes, operations for sorting the output from find_binding( ) and find_service( ) operations only are shown. In practice the interface would also provide operations for sorting output from the find_business( ), find_relatedbusinesses( ) and find_tModel( ) operations, although how these should be defined, in the light of this example, would be obvious to a skilled person.

FIG. 3 shows an example of a part of an interface description (211 of FIG. 2) which the UDDI registry defines the operation which an external ordering services must provide. The definition comprises an indication 301 of the location of the definition of the UDDI API to which the interface description applies. In this example this shown as version 3 although the invention equally applies to other versions. The interface description then defines message names ,302 and 303, which define names used in the description for the output format of the operations provided by the UDDI API. For example message name 302 defines the output format of the find_binding( ) operation and message name 303 defines the output format of the find_service( ) operation. The interface description then defines the ordering operations, order_bindings( ) 304 and order_services( ) 305, each taking as input and producing as output the output format of the find_binding( ) and find_service( ) operations, respectively.

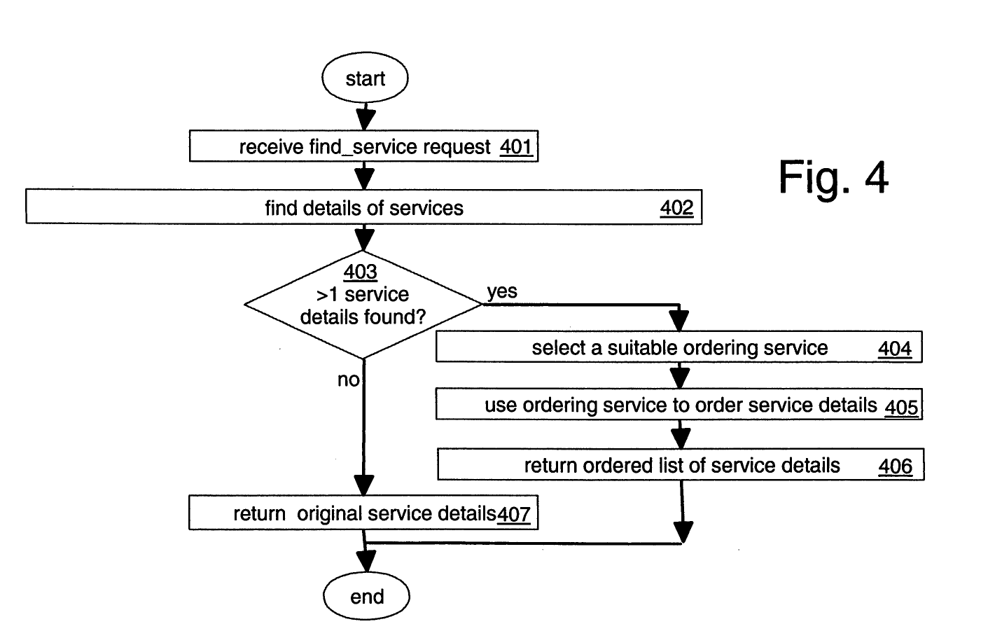

FIG. 4 is a flow diagram of a method for the UDDI registry to process an inbound request from a service requester to locate details of entities based on specified requirements, according to the preferred embodiment of the present invention. At step 401, for example, a find_service request is received from a service requester, the request specifying a criteria which returned services must meet. The UDDI registry then, at step 402, locates a plurality of details of services which satisfy the criteria specified in the request, and forms them into a list. At step 403 a check is made to see if a plurality of suitable details of services have been found and if so, at step 404 the UDDI registry selects a suitable external ordering service to use for ordering the list of details of service requirements. Note that there may be only one ordering service registered in which case no selection is necessary. Alternatively, if more than one is registered, one of these is selected based on some criteria. For example a particular ordering service could be used at a particular time of day or time period, or the ordering service could be chosen based on information received with the service requester request. Once a suitable ordering service has been chosen, at step 405 the list of service details obtained at step 402 is provided to the external ordering service for ordering and when the ordering service has completed this task, at step 406, the ordered list of service details is returned to the service requester. Note that if the check at step 403 fails because details of only a single or no suitable services were found, then an external ordering service is not called and the details are returned unmodified in response to the request at step 408.

Note that the request received at step 401 could be any of the following, in addition to find_service( ): find_binding( ), find_business( ), find_relatedbusinesses( ), or find_tModel( ).

Note that in another embodiment the ordering of a list of service details to be returned for a client could involve calling a plurality of external ordering services, each subsequent ordering service refining the ordered list of the previously called ordering service.

Note that a skilled person in the art would realise that the method described with reference to FIG. 4 could be implemented in a variety of programming languages, for example, Java^{™}, C, and C++ (Java is a registered trademark of Sun Microsystems, Inc. in the United States, other countries, or both.). Further a skilled person would realise that once implemented the methods can be stored in a computer program product comprising one or more programs, in source or executable form, on a media, such as floppy disk, CD, and DVD, suitable for loading onto a data processing host and causing the data processing host to carry out the methods. Further a skilled person would realise that the methods described with reference to FIG. 4 could be embodied in a data processing apparatus, and further used in providing a UDDI registry service.

Accordingly the present invention provides a method, apparatus, computer program product, and service which enables a UDDI registry to provide support for external ordering of entities. When a service requester contacts the registry to obtain details of entities which meet specified criteria, the registry locates a plurality of entities and provides details of these to an external ordering service. The external ordering service then orders the list according to a particular criteria, such that an ordered list is returned to the service requester. For example an entity could be a business, service, binding, or tModel.

1. A data processing method for a UDDI registry to order a list of entity details for return to a requester, the method comprising the steps:
receiving, from the requester, a standard UDDI request to locate entity details according to a specified criteria;
locating details of a plurality of entities which satisfy the criteria;
invoking an ordering service for ordering, based on a policy, the plurality of entity details into an ordered list; and
returning the ordered list to the requester.

2. The method of claim 1 further comprising the step:
receiving a request to register an ordering service with the UDDI registry.

3. The method of claim 1 further comprising the step:
invoking a second ordering service for further ordering, based on a second policy, the ordered list into a further ordered list;
wherein the step of returning returns the further ordered list.

4. The method of claim 1 wherein a different ordering service is invoked based on chronological data or information received with the request.

5. The method of claim 1 wherein the policy is based on one or more attributes associated with the entities, wherein an attribute is one of: a subscription level; a preference level; and a reliability level.

6. A data processing method for an ordering service to order a list of entity details provided by a UDDI registry, the method comprising the steps:
receiving a request from the UDDI registry, the request including a list of entity details;
ordering the entity details based on a policy; and
returning the ordered list to the UDDI registry.

7. The method of claim 6 wherein the policy is based on one or more attributes associated with the entities, wherein an attribute is one of: a subscription level; a preference level; and a reliability level.

8. A UDDI registry for ordering a list of entity details for return to a requester, the registry comprising:
means for receiving, from the requester, a standard UDDI request to locate entity details according to a specified criteria;
means for locating details of a plurality of entities which satisfy the criteria;
means for invoking an ordering service for ordering, based on a policy, the plurality of entity details into an ordered list; and
means for returning the ordered list to the requester.

9. The UDDI registry of claim 8 further comprising:
means for receiving a request to register an ordering service with the UDDI registry.

10. The UDDI registry of claim 8 further comprising:
means for invoking a second ordering service for further ordering, based on a second policy, the ordered list into a further ordered list;
wherein the step of returning returns the further ordered list.

11. The UDDI registry of claim 8 wherein a different ordering service is invoked based on chronological data or information received with the request.

12. The UDDI registry of claim 8 wherein the policy is based on one or more attributes associated with the entities, wherein an attribute is one of: a subscription level; a preference level; and a reliability level.

13. An ordering service for to order a list of entity details provided by a UDDI registry ordering a list of entity details provided by a UDDI registry, the service comprising:
means for receiving a request from the UDDI registry, the request including a list of entity details;
means for ordering the entity details based on a policy; and
means for returning the ordered list to the UDDI registry.

14. The ordering service of claim 12 wherein the policy is based on one or more attributes associated with the entities, wherein an attribute is one of: a subscription level; a preference level; and a reliability level.

15. A UDDI registry service for ordering a list of entity details for return to a requester, providing the UDDI registry service comprising carrying out the steps of claim 1.

16. An ordering service for ordering a list of entity details provided by a UDDI registry, providing the service comprising carrying out the steps of claim 6.

17. A computer program product comprising instructions which, when executed on a data processing host, cause said host to carry out a method comprising the steps of:
receiving, from the requester, a standard UDDI request to locate entity details according to a specified criteria;
locating details of a plurality of entities which satisfy the criteria;
invoking an ordering service for ordering, based on a policy, the plurality of entity details into an ordered list; and
returning the ordered list to the requester.

18. The computer program product of claim 17 wherein the method comprises the further steps of:
receiving a request to register an ordering service with the UDDI registry.

19. The computer program product of claim 17 wherein the method comprises the further step of:
invoking a second ordering service for further ordering, based on a second policy, the ordered list into a further ordered list;
wherein the step of returning returns the further ordered list.

20. The computer program product of claim 17 wherein a different ordering service is invoked based on chronological data or information received with the request.

21. The computer program product of claim 17 wherein an attribute is one of: a subscription level; a preference level; and a reliability level.

22. The computer program product of claim 17 wherein the method comprises the further step of:
receiving a request from the UDDI registry, the request including a list of entity details;
ordering the entity details based on a policy; and
returning the ordered list to the UDDI registry.
